(19) United States
(12) Patent Application Publication
(10) Pub. No.: US 2022/0009220 A1
(43) Pub. Date: Jan. 13, 2022

(54) PLATEMAKING APPARATUS AND PLATEMAKING METHOD

(71) Applicant: Konica Minolta, Inc., Tokyo (JP)

(72) Inventors: Kouji SUGAMA, Tokyo (JP); Kazuhiko NAKAJIMA, Tokyo (JP); Kengo IKEDA, Kitamoto-shi (JP)

(21) Appl. No.: 17/353,746

(22) Filed: Jun. 21, 2021

(30) Foreign Application Priority Data
Jul. 9, 2020 (JP) 2020-118585

(51) Int. Cl. B41C 1/10; B41C 1/055; B41N 3/00

(52) U.S. Cl. CPC B41C 1/1041; B41N 3/006; B41C 1/055

(57) ABSTRACT

The platemaking apparatus according to the present invention forms a pattern on an ink film-forming press plate that has a surface layer containing a stimulus-responsive compound whose physical property can reversibly change in response to an external stimulus. The platemaking apparatus includes: a first stimulator that applies, to a surface of the press plate, a first stimulus that changes the physical property of the surface from a first physical property to a second physical property to form the pattern, on the basis of image data; a second stimulator that applies, to the surface of the press plate, a second stimulus that changes the physical property of the surface from the second physical property to the first physical property, to erase the pattern; and a cleaning unit that removes an ink remained on the surface of the press plate.

### CROSS-REFERENCE TO RELATED APPLICATION

The entire disclosure of Japanese patent Application No. 2020-118585, filed on Jul. 9, 2020, is incorporated herein by reference in its entirety.

### BACKGROUND

### 1. Technical Field

The present invention relates to a platemaking apparatus and a platemaking method.

### 2. Description of Related Arts

There are two major methods of lithographic printing. One is a method in which a hydrophilic part and a hydrophobic part are provided on a surface of a lithographic plate, the hydrophilic part being preliminarily wet by immersion in water, a non-water-miscible ink is then applied over the surface of the lithographic plate to form an ink film structure (a liquid film structure) having the ink adhered only in the hydrophobic part, and the structure is transferred to accomplish printing. In another method, a lithographic plate having stacked thereon a photosensitive layer and a silicone rubber layer in sequence is subjected to partial light exposure and development, to remove a part of the photosensitive layer together with the silicone rubber layer, or to remove the silicone rubber layer only. There is therefore provided a method of waterless lithographic printing without using water, in which printing is enabled by using a lithographic plate having formed thereon a pattern that includes a non-image area where the silicone rubber layer exposes, and an image area from which at least the silicone rubber layer has been removed.

Although a surface of the press plate in the lithographic printing would seem to be free of convex shape and concave shape, the lithographic plate used in the waterless printing method, for example, has a height difference which is at least not smaller than the thickness of the silicone rubber layer, between the image area and the non-image area formed on the lithographic plate, and is therefore not understood to be flat in a strict sense. In addition, the lithographic plate is formed through steps of coating, light exposure and development, consuming vast man-hour, and being unable to be formed by simple steps. Furthermore, as can be understood from the manufacturing process, the pattern of the lithographic plate cannot be easily rewritten.

That is, the prior lithographic printing (analog printing) cannot easily modify the lithographic plate on which a printing pattern is once formed, so that the lithographic plate needs to be created from the beginning every time a different printed material is produced, posing a problem of time loss and cost increase every time the lithographic plate is created. In addition, there is an environmental disadvantage that the old plate is discarded each time a new plate is made.

In order to overcome such disadvantages, conventionally proposed is a technique of rewriting the press plate by using two types of stimulus. For example, JP 2007-98945A (corresponded to US 2007/0087289 A1) uses, as a print plate, a polymer layer capable of forming and erasing a pattern. According to the technique described in JP 2007-98945A (corresponded to US 2007/0087289 A1), the polymer layer is subjected to a photocatalytic treatment and/or a photochemical treatment, to form the pattern. On the other hand, the pattern formed in the polymer layer is made erasable by an action of electromagnetic beam, and/or an action of heat, and/or an action of at least one solvent, and/or removal by polishing.

### SUMMARY

The technique described in JP 2007-98945A (corresponded to US 2007/0087289 A1) can erase the pattern on the press plate by using external stimuli such as the action of electromagnetic beam, and/or the action of heat, and/or the action of at least one solvent, and/or removal by polishing.

The technique described in JP 2007-98945 (corresponded to US 2007/0087289 A1), however, erases or rewrites the pattern by applying the external stimulus, with the ink remained on the press plate. Hence, the residual ink would disturb the external stimulus, partially disabling erasure or rewriting of the pattern. As a consequence, even when printing by using a press plate with a new pattern rewritten thereon, it was found to result in printing of the pattern on the previous press plate, posing a problem (referred to as “fogging”, hereinafter) that an image of the previous press plate (also referred to as “previous image”, hereinafter) overlaps with an image of a new press plate, for example.

It is, therefore, an object of the present invention to provide a platemaking apparatus and a platemaking method, capable of recycling the press plate, and capable of obtaining a good printed image without fogging caused by a previous image, even when printed by using a press plate with a new pattern rewritten thereon.

The present inventors went through extensive examinations. As a consequence, the present inventors have found that the above problems can be solved by the following platemaking apparatus, and have completed the present invention.

Aimed at achieving at least one of the above objects, a platemaking apparatus according to one aspect of the present invention, intended for use with a press plate that has a surface layer containing a stimulus-responsive compound whose physical property can reversibly change in response to an external stimulus, includes a first stimulator that writes a pattern on the press plate, and a second stimulator that erases the pattern, as well as a cleaning unit that removes the ink remained on the press plate after printing.

That is, a platemaking apparatus according to one aspect of the present invention is a platemaking apparatus for forming a pattern on an ink film-forming press plate that has a surface layer containing a stimulus-responsive compound whose physical property can reversibly change in response to an external stimulus, the platemaking apparatus includes: a first stimulator that applies, to a surface of the press plate, a first stimulus that changes the physical property of the surface from a first physical property to a second physical property to form the pattern, on the basis of image data; a second stimulator that applies, to the surface of the press plate, a second stimulus that changes the physical property of the surface from the second physical property to the first physical property, to erase the pattern; and a cleaning unit that removes an ink remained on the surface of the press plate.

In addition, the present inventors have found that the above problems can be solved by the following platemaking method, and have completed the present invention.

Aimed at achieving at least one of the above objects, a platemaking method according to one aspect of the present invention includes: applying, to a surface of an ink film-forming press plate that has a surface layer containing a stimulus-responsive compound whose physical property can reversibly change in response to an external stimulus, a first stimulus that changes the physical property of the surface from a first physical property to a second physical property to form a pattern, on the basis of image data; forming an ink film on either an image area or a non-image area of the press plate having the pattern formed thereon; performing printing with use of the press plate having the ink film formed thereon; applying, to a surface of the press plate after printing, a second stimulus that changes the physical property of the surface from the second physical property to the first physical property, to erase the pattern; forming a new image pattern by applying the first stimulus to the surface of the press plate from which the pattern has been erased; and cleaning the ink remained on the surface of the press plate after the printing, in either timing after the printing and before the applying of the second stimulus, or after the applying of the second stimulus and before the forming of the new image pattern.

### BRIEF DESCRIPTION OF THE DRAWINGS

The advantages and features provided by one or more embodiments of the present invention may be more fully understood by the following detailed description and the appended drawings. It should be noted that the drawings are shown for the purpose of illustration only and are not intended to define the scope of the present invention.

FIG. 1 is a schematic drawing illustrating a platemaking apparatus according to an embodiment of the present invention;

FIG. 2 is a schematic drawing illustrating a platemaking apparatus according to an embodiment of the present invention;

FIG. 3 is a schematic drawing illustrating a platemaking apparatus according to an embodiment of the present invention;

FIG. 4 is a schematic drawing illustrating a platemaking apparatus according to an embodiment of the present invention;

FIG. 5 is a schematic drawing illustrating a platemaking apparatus according to an embodiment of the present invention;

FIG. 6 is a schematic drawing illustrating a platemaking apparatus according to an embodiment of the present invention;

FIG. 7 is a perspective view illustrating a main part of a printing apparatus according to an embodiment of the present invention;

FIG. 8 is a schematic drawing illustrating a platemaking apparatus according to an embodiment of the present invention;

FIG. 9 is a schematic drawing illustrating a platemaking apparatus according to a comparative example;

FIG. 10 is a drawing illustrating an image pattern on the surface of a press plate in initial printing used for evaluation; and

FIG. 11 is a view illustrating an image pattern on the surface of a rewritten press plate used for evaluation.

### DETAILED DESCRIPTION OF EMBODIMENTS

Hereinafter, an embodiment of the present invention will be described with reference to the drawings. The scope of the present invention is, however, not limited to the disclosed embodiment.

A platemaking apparatus according to one aspect of the present invention is a platemaking apparatus for forming a pattern on an ink film-forming press plate that has a surface layer containing a stimulus-responsive compound whose physical property can reversibly change in response to an external stimulus, the platemaking apparatus includes: a first stimulator that applies, to a surface of the press plate, a first stimulus that changes the physical property of the surface from a first physical property to a second physical property to form the pattern, on the basis of image data; a second stimulator that applies, to the surface of the press plate, a second stimulus that changes the physical property of the surface from the second physical property to the first physical property, to erase the pattern; and a cleaning unit that removes an ink remained on the surface of the press plate. According to the platemaking apparatus with such structure, the press plate can be recycled, and a good printed image without fogging caused by a previous image is obtainable even when printed by using a press plate with a new pattern rewritten thereon.

Although the reason why the above effect is obtainable with use of the platemaking apparatus according to the embodiment of the present invention remains unclear, possible mechanism is as follows. Note that the following mechanism is merely a matter of speculation, to which the present invention is by no means limited.

According to the technique described in JP 2007-98945A (corresponded to US 2007/0087289 A1) described above, the pattern is erased by applying an external stimulus (second stimulus) such as an action of electromagnetic beam, and/or an action of heat, and/or an action of at least one solvent, and/or removal by polishing, with the ink remained on the press plate. With the ink remained on the surface of the press plate, when erasing the pattern by using the second stimulus, or when rewriting the pattern by using the external stimulus (first stimulus) such as photocatalytic treatment and/or photochemical treatment, the residual ink would disturb changes in the surface physical property in response to these external stimuli. Hence supposedly, the pattern is not fully erased, or the pattern is not fully rewritten, causing fogging with the previous image.

In contrast, the platemaking apparatus according to an embodiment of the present invention includes the first stimulator that applies the first stimulus that changes the physical property of the surface of the press plate from a first physical property to a second physical property, to form the pattern on the surface of the press plate; and the second stimulator that applies the second stimulus that changes the physical property of the surface from the second physical property to the first physical property, to erase the pattern; as well as the cleaning unit that removes an ink remained on the surface of the press plate. By sufficiently removing the ink remained on the surface of the press plate by the cleaning unit, it is possible to prevent the pattern of the previous image from being printed by the remained ink, and to prevent the ink from easily getting on the remained ink and from causing fogging. In addition, since the changes in the physical property of the surface in response to the external stimuli certainly occur, fogging of the previous image when printed by using the rewritten press plate is further suppressible.

As described above, the platemaking apparatus according to one embodiment of the present invention can suppress image defects due to the residual ink, through removal of the ink remained on the surface of the press plate by using the cleaning member. In addition, the residual ink is prevented from disturbing the changes in the physical property of the surface in response to the external stimuli. The physical property of the surface can therefore certainly change, well suppressing the fogging with the previous image. In addition, since the platemaking apparatus according to an embodiment of the present invention writes and erases the pattern, by applying two types of external stimuli, being the first stimulus and the second stimulus, to the press plate that has the surface layer containing the stimulus-responsive compound whose surface physical property can reversibly change in response to the external stimuli, so that the press plate is recyclable.

In addition, the platemaking apparatus according to the embodiment of the present invention needs neither solvent nor process liquid when the image pattern is formed or erased, and does not discharge waste liquid, so that the environmental impact can be reduced.

Hereinafter, a structure of the platemaking apparatus according to an embodiment of the present invention will be described.

In the present specification, “X to Y” indicating a numerical range means “X or more and Y or less”, including X and Y. In the present specification, unless otherwise specified, operations and measurements of physical properties and so forth are performed under conditions of room temperature (20 to 25° C.) and a relative humidity of 40 to 50% RH.

[Ink Film-Forming Press Plate]

The platemaking apparatus according to an embodiment of the present invention is a platemaking apparatus that forms a pattern on the ink film-forming press plate in a repeatedly rewritable manner, wherein the ink film-forming press plate has the surface layer that contains the stimulus-responsive compound whose physical property can reversibly change in response to the external stimuli.

[Structure of Press Plate]

The ink film-forming press plate (also referred to as “press plate” or “press plate for forming an ink film”) used in the platemaking apparatus according to one embodiment of the present invention preferably has the surface layer that contains the stimulus-responsive compound and a resin, arranged on a support.

(Support)

The shape of the support is not particularly limited, and examples thereof include flat plate shape, cylindrical shape, and the like.

Also the material of the support is not particularly limited, and examples thereof include metals such as aluminum, aluminum alloy (alloy of aluminum and magnesium or/and silicon, and the like), iron and stainless steel; and plastics such as polyethylene terephthalate (PET), polybutylene terephthalate (PBT), polyacrylonitrile, polyvinyl chloride, epoxy resin, phenol resin and styrene-butadiene rubber. These may be used singly or in combination of two or more kinds thereof.

The support may have either a single layer form or a multilayer form. In the multilayer form, the individual layers may be made of different materials.

(Surface Layer)

<Resin>

The surface layer may contain a resin. The resin contained in the surface layer is not particularly limited, and both thermoplastic resin and thermosetting resin can be used.

Examples of the thermoplastic resin include polyolefin resins such as polyethylene and polypropylene; cyclic polyolefin resins; polyester resins such as polyethylene terephthalate and polybutylene terephthalate; polyvinyl chloride resin, polyvinylidene chloride resin, polytetrafluoroethylene resin, polystyrene resin, polyether resin, polyvinyl acetate resin, acrylonitrile-butadiene-styrene (ABS) resin, acrylonitrile-styrene (AS) resin, acrylic resin, styrene acrylic resin, polyimide resin, polyacetal resin, polycarbonate resin, modified polyphenylene ether resin, polybutylene terephthalate resin, polyethylene terephthalate resin, polyphenylene sulfide resin, polysulfone resin, polyether sulfone resin, amorphous polyarylate resin, liquid crystal polymer, polyether ether ketone resin, thermoplastic polyimide resin, polyamideimide resin, copolymers thereof, and the like.

Examples of the thermosetting resin include a solid epoxy resin, silicone resin, silicone-modified resin, formaldehyde resin, phenol resin, melamine resin, urea resin, benzoguanamine resin, unsaturated polyester resin, alkyd resin, diallyl phthalate resin, polyurethane resin, thermosetting polyimide resin, crosslinked acrylic resin (for example, crosslinked polymethyl methacrylate resin), crosslinked polystyrene resin, polyamic acid resin (a resin that is imidized by heating to form a polyimide structure), and the like.

The resins may be used singly or in combination of two or more kinds thereof. Other applicable examples may include hybrid resin in which two or more kinds of polymerized segments (resin segments) are bound to each other, such as resin having a vinyl polymerized segment (vinyl resin segment) and a polyester polymerized segment (polyester resin segment).

Among them, thermoplastic resin is preferred from the viewpoint that the hydrophilicity of the stimulus-responsive compound will be more likely to change, wherein styrene acrylic resin, polycarbonate resin, polyethylene terephthalate resin, and polyolefin resin are more preferred.

As the resin contained in the surface layer, both synthetic product and commercially available product can be used. Examples of the commercially available resin product include VS-1063 (weight average molecular weight: 5,500), US-1071 (weight average molecular weight: 10,000), X-1 (weight average molecular weight: 18,000), YS-1274 (weight average molecular weight: 19,000), VS-1047 (weight average molecular weight: 10,000), RS-1191 (weight average molecular weight: 6,500), and the like, manufactured by SEIKO PMC Corporation.

The weight average molecular weight of the resin contained in the surface layer is not particularly limited, and is preferably 5,000 to 30,000, and more preferably 8,000 to 20,000.

The content of the resin in the surface layer is preferably 30 to 80% by mass, and more preferably 40 to 70% by mass relative to the total mass of the stimulus-responsive compound and the resin contained in the surface layer. Within such range, strength of the surface layer may be improved while maintaining rapid stimulus responsiveness.

Note that the weight average molecular weight employed in the present specification is a value measured by gel permeation chromatography (GPC).

<Stimulus-Responsive Compound>

The stimulus-responsive compound refers to a compound that reversibly changes its property in response to the external stimulus. The present invention uses the stimulus-responsive compound whose surface physical property can reversibly change in response to two external stimuli, being the first stimulus and the second stimulus, that is, can change from the first physical property to the second physical property in response to the first stimulus, and can change from the second physical property to the first physical property in response to the second stimulus. Preferably, the stimulus-responsive compound whose hydrophilicity can reversibly change in response to the external stimulus is used.

The phrase “whose hydrophilicity can reversibly change in response to the external stimuli” means that the compound to which an external stimulus is applied can reversibly change between hydrophilic form and hydrophobic form in response to the external stimuli.

Here, “(the compound) can reversibly change between hydrophilicity and hydrophobicity” specifically means that an existing form of molecule can change in response to the external stimulus, becoming changeable between hydrophilic form and hydrophobic form. The existing form of the molecule refers to molecular structure or aggregation state of molecules. For example, a photoresponsive compound can be controlled as hydrophilic or hydrophobic depending on whether the hydroxy group is oriented on the surface or not, by changing the molecular structure in response to light, meanwhile a temperature-responsive compound can be controlled as hydrophilic or hydrophobic, by changing the aggregation state of the molecules in response to temperature.

As described above, the present invention preferably uses the stimulus-responsive compound whose hydrophilicity can reversibly change in response to the external stimuli. The physical property of the surface of the press plate can preferably change from hydrophobicity to hydrophilicity in response to the first stimulus, and can preferably change from hydrophilicity to hydrophobicity in response to the second stimuli. Alternatively, the physical property of the surface of the press plate can preferably change from hydrophilicity to hydrophobicity in response to the first stimulus, and can preferably change from hydrophobicity to hydrophilicity in response to the second stimulus. Upon change between hydrophilicity and hydrophobicity, a high-quality image is obtainable, with high ink controllability according to the image pattern.

The external stimulus, although not particularly limited, is exemplified by light, temperature change, pressure, electric field, pH, and the like.

Examples of the stimulus-responsive compound include a photoresponsive compound whose hydrophilicity can reversibly change in response to light, temperature-responsive compound whose hydrophilicity can reversibly change in response to temperature change, electric field-responsive compound whose hydrophilicity can reversibly change in response to electric field, pH-responsive compound whose hydrophilicity can reversibly change in response to pH, and the like.

As the stimulus-responsive compound, both synthetic product and commercially available product can be used. The stimulus-responsive compound may be used singly or in combination of two or more kinds thereof. Among them, photoresponsive compound or temperature-responsive compound is preferred in view of its high rate of change of hydrophilicity.

Therefore, in a preferred embodiment of the present invention, the first stimulus and the second stimulus, being the external stimuli, are lights with different wavelengths, and the stimulus-responsive compound is a photoresponsive compound. In another preferred embodiment, the first stimulus and the second stimulus, being the external stimuli, are different temperature changes, and the stimulus-responsive compound is a temperature-responsive compound.

Hereinafter, the photoresponsive compound and the temperature-responsive compound, which are preferred stimulus-responsive compounds, will be described.

<Photoresponsive Compound>

The photoresponsive compound used in the present invention is preferably a compound that can cause stereoisomerization or structural isomerization (cis-trans isomerization, photo-ring-opening reaction, etc.) upon irradiation of light, and can reversibly change the hydrophilicity. Specific examples of such compound include compounds having an azobenzene structure that contains a hydrophilic group; compounds having a spiropyran structure that contains a hydrophilic group; compounds having a stilbene structure that contains a hydrophilic group; compounds having a diarylethene structure that contains a hydrophilic group; and the like. These compounds may be in the form of a polymer or a crosslinked form of the polymer.

Among them, compounds having an azobenzene structure that contains a hydrophilic group; compounds having a stilbene structure that contains a hydrophilic group; and polymers having skeletons derived from these compounds, all causing cis-trans isomerization upon irradiation of light, are preferred in view of their high rate of change of hydrophilicity.

Examples of the hydrophilic group include hydroxy group, carboxy group, mercapto group, sulfonate group, sulfate group, phosphate group, amino group, and the like. These hydrophilic groups may be used singly or in combination of two or more kinds thereof. Among them, the hydrophilic group is preferably hydroxy group in view of its high rate of change of hydrophilicity.

Specifically, the compound having an azobenzene structure that contains a hydrophilic group is preferably a compound represented by the following chemical formula (1).

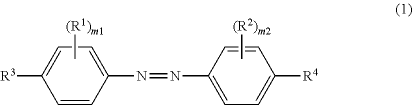

In chemical formula (1), each of R¹ and R² independently represents a hydrophilic group, each of R³ and R⁴ independently represents an alkyl group having 1 to 18 carbon atoms or an alkoxy group having 1 to 18 carbon atoms, each of m1 and m2 independently represents an integer of 0 to 4, where m1+m2 represents an integer of 1 to 8.

Each of R¹ and R² in chemical formula (1) independently represents a hydrophilic group. Examples of the hydrophilic groups are as described above. When m1+m2 represents an integer of 2 to 8, the plurality of hydrophilic groups may be the same, or different from each other.

Each of R³ and R⁴ in chemical formula (1) independently represents an alkyl group having 1 to 18 carbon atoms or an alkoxy group having 1 to 18 carbon atoms.

Examples of the alkyl group having 1 to 18 carbon atoms include linear alkyl groups such as methyl group, ethyl group, n-propyl group, n-butyl group, n-pentyl group, n-hexyl group, n-heptyl group, n-octyl group, n-nonyl group, n-decyl group, n-undecyl group, n-dodecyl group, n-tridecyl group, n-tetradecyl group, n-pentadecyl group, and n-hexadecyl group; branched alkyl groups such as isopropyl group, isobutyl group, sec-butyl group, t-butyl group, isoamyl group, t-pentyl group, neopentyl group, 1-methylpentyl group, 4-methyl-2-pentyl group, 3,3-dimethylbutyl group, 2-ethylbutyl group, 1-methylhexyl group, t-octyl group, 1-methylheptyl group, 2-ethylhexyl group, 2-propylpentyl group, 2,2-dimethylheptyl group, 2,6-dimethyl-4-heptyl group, 3,5,5-trimethylhexyl group, 1-methyldecyl group, and 1-hexylheptyl group; and the like.

Examples of the alkoxy group having 1 to 18 carbon atoms include linear alkoxy groups such as methoxy group, ethoxy group, n-propoxy group, n-butoxy group, n-pentyloxy group, n-hexyloxy group, n-heptyloxy group, n-octyloxy group, n-nonyloxy group, n-decyloxy group, n-undecyloxy group, n-dodecyloxy group, n-tridecyloxy group, n-tetradecyloxy group, n-pentadecyloxy group, and n-hexadecyloxy group; branched alkoxy groups such as isopropoxy group, t-butoxy group, 1-methylpentyloxy group, 4-methyl-2-pentyloxy group, 3,3-dimethylbutyloxy group, 2-ethylbutyloxy group, 1-methylhexyloxy group, t-octyloxy group, 1-methyheptyloxy group, 2-ethylhexyloxy group, 2-propylpentyloxy group, 2,2-dimethylheptyloxy group, 2,6-dimethyl-4-heptyloxy group, 3,5,5-trimethylhexyloxy group, 1-methyldecyloxy group, and 1-hexylheptyloxy group; and the like.

More specific examples of the compound having an azobenzene structure that contains a hydrophilic group preferably include compounds represented by the following chemical formulae (2) and (3).

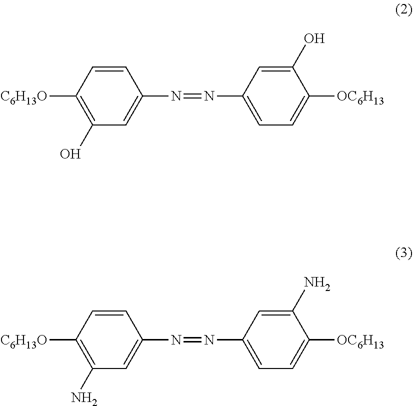

Specifically, the compound having a stilbene structure that contains a hydrophilic group is preferably a compound represented by the following chemical formula (4).

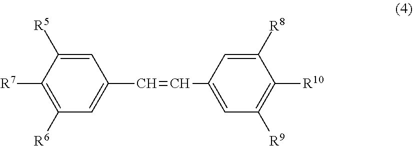

In chemical formula (4), each of R⁵ to R¹⁰ independently represents a hydrogen atom, an alkoxy group having 1 to 6 carbon atoms, or a hydrophilic group, wherein at least one of R⁵ to R¹⁰ represents a hydrophilic group.

Examples of the alkoxy group having 1 to 6 carbon atoms include methoxy group, ethoxy group, n-propoxy group, isopropoxy group, n-butoxy group, isobutoxy group, sec-butoxy group, t-butoxy group, n-pentyloxy group, isopentyloxy group, sec-pentyloxy group, t-pentyloxy group, and n-hexyloxy group.

Examples of the hydrophilic groups are as described above.

More specific examples of the compound having a stilbene structure that contains a hydrophilic group preferably include a compound represented by the following chemical formula (5) (isorhapontigenin, or 3,4′,5-trihydroxy-3′-methoxy-trans-stilbene).

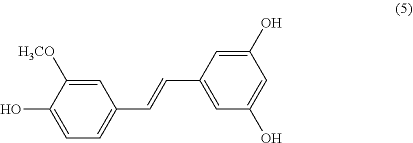 [SMILES: COc1cc(/C=C/c2cc(O)cc(O)c2)ccc1O]

Examples of the photoresponsive compound in the form of polymer preferably include a polymer represented by the following chemical formula (6).

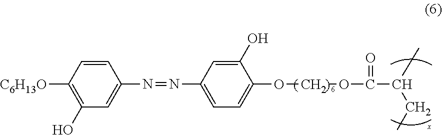

In chemical formula (6), x represents the number of repeating units, typically in the range from 20 to 1000, although not specifically limited within the polymer range.

The photoresponsive compounds may be used singly or in combination of two or more kinds thereof. As the photoresponsive compound, both commercially available product and synthetic product can be used.

Examples of a method for synthesizing the compounds having an azobenzene structure that contains a hydrophilic group include the following methods.

Examples of the method for synthesizing the azobenzene compound represented by chemical formula (2) include a method represented by the following reaction formula A. 2-Chloro-4-aminophenol and sodium nitrite are allowed to react under cooling to synthesize a diazonium salt, and the product is allowed to react with 2-chlorophenol. Thereafter, the obtained intermediate A is allowed to react with n-bromohexane to synthesize intermediate B. Subsequently, the obtained intermediate B is allowed to react with an aqueous sodium hydroxide solution at high temperatures and high pressures, and then treated with an acid, whereby an azobenzene compound (azobenzene derivative (1)) represented by chemical formula (2) can be obtained.

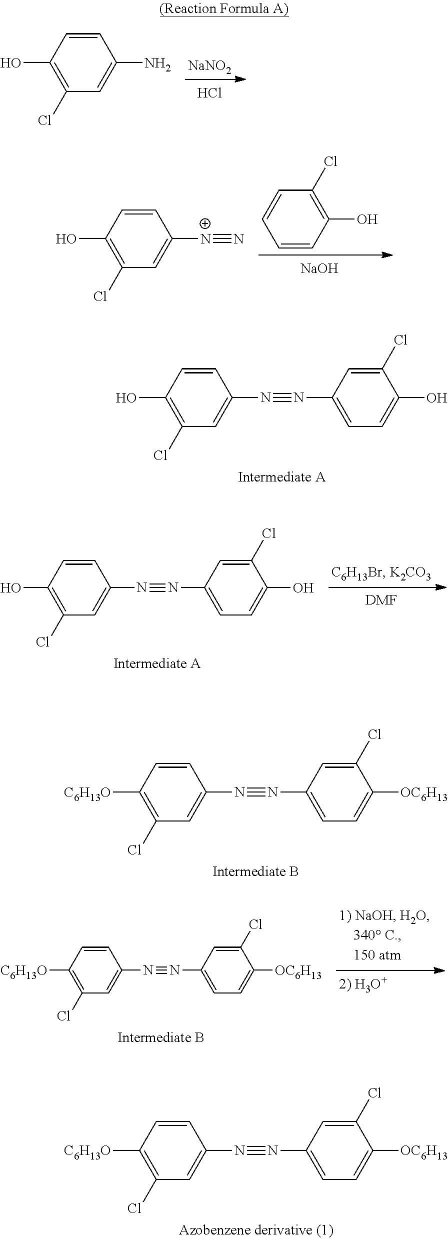

Examples of the method for synthesizing the azobenzene compound (azobenzene derivative (3)) represented by chemical formula (3) include a method in which intermediate B in reaction formula A is allowed to react with potassium amide in liquid ammonia (see reaction formula B below).

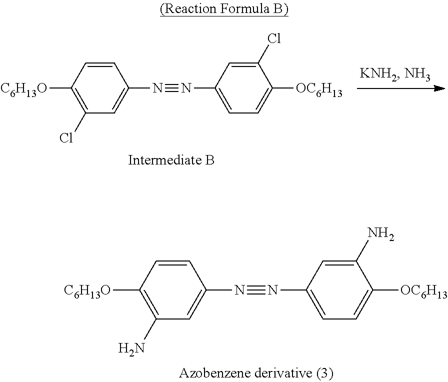

Examples of the method for synthesizing the polymer represented by chemical formula (6) include a method represented by reaction formula C below. A diazonium salt is synthesized in the same way as represented by reaction formula A, and is then allowed to react with 2-chlorophenol to obtain intermediate C. Subsequently, intermediate C is allowed to react with n-bromohexanol to synthesize intermediate D. Subsequently, intermediate D and acrylic acid chloride are allowed to react in the presence of triethylamine to obtain an acrylate monomer (intermediate E) having an azobenzene structure. Subsequently, the chloro group is converted to a hydroxy group to give intermediate F. The obtained intermediate F is subjected to a polymerization reaction with use of 2,2′-azobisisobutyronitrile (AIBN) as a polymerization initiator, whereby an azobenzene compound (azobenzene derivative (polymer 2)) represented by the chemical formula (6) can be obtained.

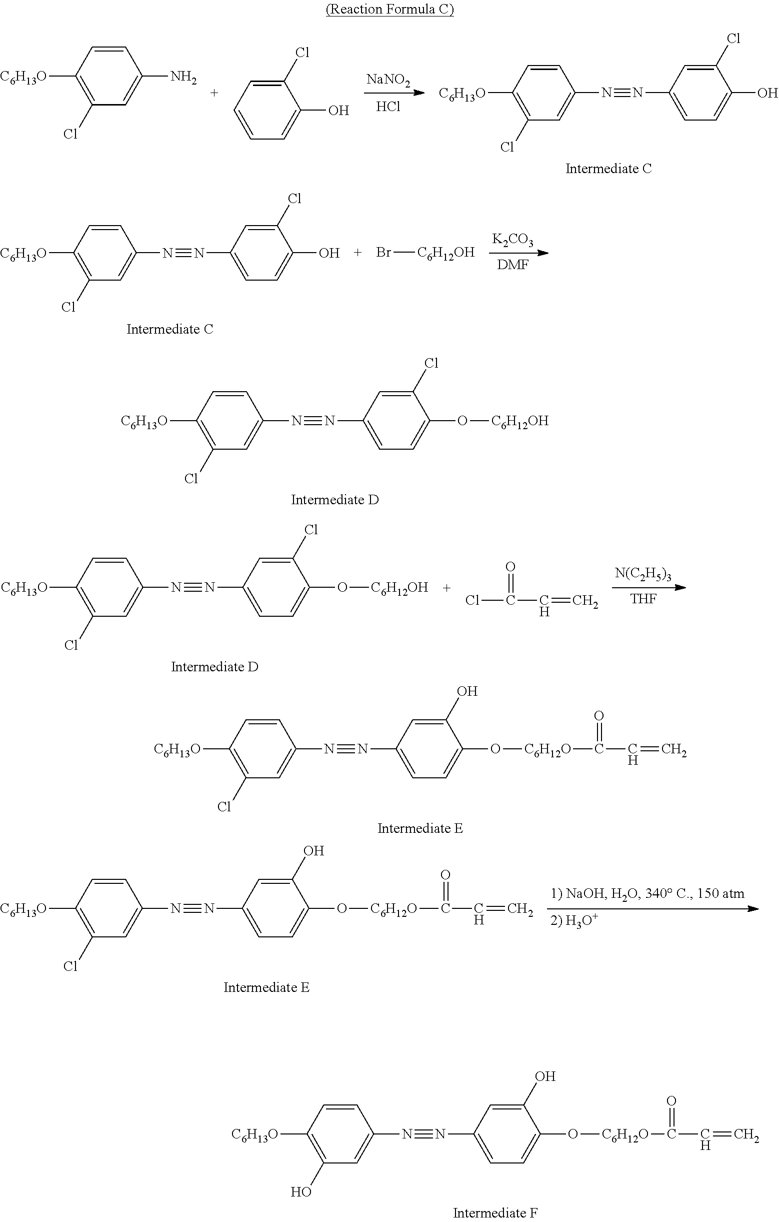

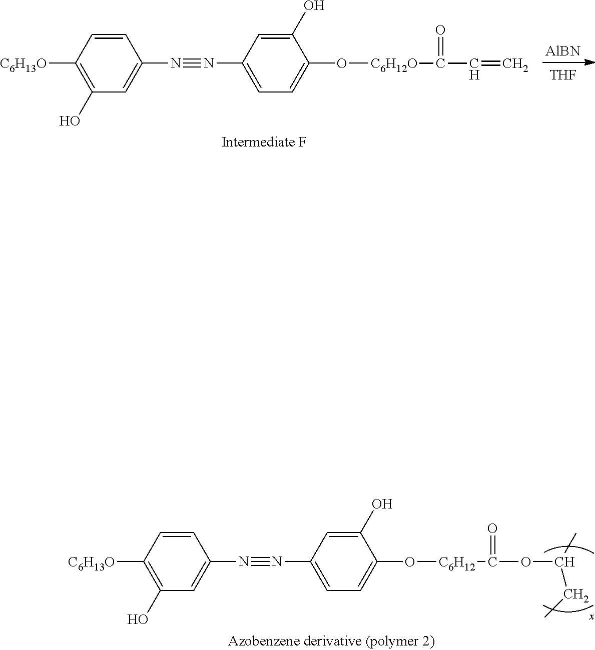

<Temperature-Responsive Compound>

The temperature-responsive compound used in the present invention is preferably a compound whose hydrophilicity can reversibly change in response to temperature change. The temperature-responsive compound preferably changes reversibly from hydrophobic (or hydrophilic) to hydrophilic (or hydrophobic), at critical solution temperature (CST) in water. The temperature-responsive compound applicable here may be either:

(1) temperature-responsive compound that exhibits hydrophilicity at a temperature below the critical solution temperature (the critical solution temperature at this point is particularly referred to as “lower critical solution temperature (LCST)”), while exhibiting hydrophobicity at a temperature equal to or above the critical solution temperature; or

(2) temperature-responsive compound that exhibits hydrophilicity at a temperature equal to or above the critical solution temperature (the critical dissolution temperature at this point is particularly referred to as “upper critical solution temperature (UCST)”), while exhibiting hydrophobicity at a temperature below the critical solution temperature.

The temperature-responsive compound, although not particularly limited, is exemplified by acrylic polymers and methacrylic polymers. Specific examples include polymers having a constitutional unit derived from N-substituted (meth)acrylamide, such as poly(N-n-propylacrylamide) (LCST: 21° C.), poly(N-n-propylmethacrylamide) (LCST: 27° C.), poly(N-isopropylacrylamide) (LCST: 32° C.), poly(N-isopropylmethacrylamide) (LCST: 43° C.), poly(N-ethoxyethylacrylamide) (LCST: ca. 35° C.), poly(N-tetrahydrofurfurylacrylamide) (LCST: ca. 28° C.), poly(N-tetrahydrofurfurylmethacrylamide) (LCST: ca. 35° C.), poly(N,N-diethylacrylamide) (LCST: 32° C.), poly-N,N-ethylmethylacrylamide (LCST: 56° C.), poly(N-ethylacrylamide), poly(N-cyclopropylacrylamide) (LCST: 45° C.) and poly(N-cyclopropylmethacrylamide); poly(N-acryloylpyrrolidine), poly(N-acryloylpiperidine), polymethyl vinyl ether, copolymers thereof, and the like.

Other examples of the temperature-responsive compound include alkyl-substituted cellulose derivatives such as methyl cellulose, ethyl cellulose, and hydroxypropyl cellulose; polyalkylene oxide block copolymers such as block copolymer of polypropylene oxide and polyethylene oxide; and the like.

Among these temperature-responsive compounds, polymer having a constitutional unit derived from N-substituted (meth)acrylamide is preferred, considering that the terminal thereof is easily modified into a functional group such as carboxylate group, amine group or maleimide group; or considering that the compound will have pH responsiveness when copolymerized with methacrylic acid, for example.

These temperature-responsive compounds, although not particularly limited, can be obtained by polymerizing a monomer under radiation exposure, or by solution polymerization.

The monomer employable here may be such that a homopolymer, obtainable by polymerizing it, can demonstrate temperature responsiveness (also referred to as “temperature-responsive monomer”, hereinafter). The temperature-responsive monomer, although not particularly limited, is exemplified by N-(or N,N-di)-substituted (meth)acrylamide compounds, (meth)acrylamide compounds having a cyclic group, vinyl ether compounds, and the like. The temperature-responsive compound may be a homopolymer obtainable by polymerizing one kind of temperature-responsive monomer, or may be a copolymer obtainable by polymerizing two or more kinds of temperature-responsive monomer. The copolymer may be any of a graft copolymer, block copolymer, and random copolymer.

The temperature-responsive compound may also be a copolymer obtainable optionally by polymerizing a monomer component that is not categorized per se as the temperature-responsive monomer, in addition to the aforementioned temperature-responsive monomer, without inhibiting the temperature responsiveness. The copolymer may be any of random copolymer, block copolymer, and graft copolymer.

Furthermore, the temperature-responsive compound may be crosslinked products of these polymers. For the case where the temperature-responsive polymer is a crosslinked product, such crosslinked product is exemplified by polymers obtainable by polymerizing, in the presence of a crosslinking agent, one of, or two or more kinds of monomers that include N-alkyl (meth)acrylamides such as N-methyl (meth)acrylamide, N-ethyl (meth)acrylamide, N-n-propyl (meth)acrylamide, N-isopropyl (meth)acrylamide, N-n-butyl (meth)acrylamide, N-isobutyl (meth)acrylamide, and N-t-butyl (meth)acrylamide; N-vinylalkylamides such as N-vinylisopropylamide, N-vinyl-n-propylamide, N-vinyl-n-butyramide, N-vinylisobutyramide and N-vinyl-t-butyramide; vinyl alkyl ethers such as vinyl methyl ether and vinyl ethyl ether; alkylene oxides such as ethylene oxide and propylene oxide; 2-alkyl-2-oxazolines such as 2-ethyl-2-oxazoline, 2-n-propyl-2-oxazoline and 2-isopropyl-2-oxazoline; and the like.

The crosslinking agent is suitably selectable for use from among known ones, which are exemplified by crosslinkable monomer having a polymerizable functional group, such as ethylene glycol di(meth)acrylate, propylene glycol di(meth)acrylate, N,N′-methylene bis(meth)acrylamide, tolylene diisocyanate, divinylbenzene, or polyethylene glycol di(meth)acrylate; glutaraldehyde; polyhydric alcohol; polyvalent amine; polycarboxylic acid; metal ions such as calcium ion and zinc ion; and the like. These crosslinking agents may be used singly, or may be used in combination of two or more thereof.

The molecular weight of the temperature-responsive compound is not particularly limited, wherein the number-average molecular weight measured by gel permeation chromatography (GPC) is preferably 3,000 or more.

The temperature-responsive compound may be used singly or in combination of two or more kinds thereof. As the temperature-responsive compound, both commercially available product and compound obtained by synthesis as described above can be used.

Content of the stimulus-responsive compound in the surface layer is preferably 20 to 70% by mass, and more preferably 30 to 60% by mass, assuming the total mass of the stimulus-responsive compound and the resin contained in the surface layer is 100% by mass. Within such range, the strength of the surface layer can be improved, while maintaining rapid stimulus responsiveness.

(Other Components)

The surface layer may further contain antioxidant, plasticizer, metal oxide particle and so forth, without inhibiting the effect of the present invention. The thickness (dry thickness) of the surface layer, although not particularly limited, is preferably 3 to 30 μm, and more preferably 5 to 10 μm.

(Adhesive Layer)

The ink film-forming press plate may have the surface layer arranged on the support while placing an adhesive layer in between.

An adhesive used for forming the adhesive layer (also referred to as “adhesive layer-forming adhesive”, hereinafter), although not particularly limited, is preferably a curable composition that contains a curable resin, and optional polymerization initiator, solvent and so forth.

The curable resin may be active energy ray (for example, ultraviolet ray, visible ray, X-ray, electron beam, and so forth)-curable type, or thermosetting type, which is preferably an active energy ray-curable type, and more preferably an ultraviolet curable type. The curable resin may be used singly or in combination of two or more kinds thereof. As the curable resin, both commercially available product and synthetic product can be used.

Examples of the ultraviolet curable resin suitably applicable here include ultraviolet curable urethane acrylate resin, ultraviolet curable polyester acrylate resin, ultraviolet curable epoxy acrylate resin, ultraviolet curable polyol acrylate resin, ultraviolet curable epoxy resin, and the like. Among them, ultraviolet curable urethane acrylate resin and ultraviolet curable polyol acrylate resin are preferred.

The ultraviolet curable polyol acrylate resin is exemplified by ethylene glycol (meth)acrylate, polyethylene glycol di(meth)acrylate, glycerin tri(meth)acrylate, trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, alkyl-modified dipentaerythritol penta(meth)acrylate, and the like. As the ultraviolet curable polyol acrylate resin, commercially available product can be used, which is exemplified by Sartomer (registered trademark) SR295, 350, 399 (manufactured by Sartomer), and the like.

The polymerization initiator is suitably selectable for use from among known photopolymerization initiator, thermal polymerization initiator and so forth, depending on the type of the curable resin to be used. As the adhesive for forming the adhesive layer, both commercially available product and synthetic product can be used.

For curing of the adhesive under irradiation with the active energy ray, irradiation conditions (type of light source, irradiation intensity, irradiation time, and so forth) are appropriately selectable. The light source applicable here includes known light sources such as low-pressure mercury lamp, high-pressure mercury lamp, xenon lamp and metal halide lamp. The irradiation intensity, although not particularly limited, is typically 10 to 200 mW/cm². The irradiation time, although not particularly limited, is typically 1 to 10 minutes. Also when curing the adhesive under heating, the heating temperature and the heating time are appropriately adjustable.

The thickness (dry thickness) of the adhesive layer, although not particularly limited, is preferably 0.5 to 3

### [Method for Manufacturing Ink Film-Forming Press Plate]

The method for manufacturing the ink film-forming press plate (the press plate for forming an ink film), although not particularly limited, is exemplified by a method in which a surface layer-forming solution that contains the stimulus-responsive compound and the resin is prepared, and the solution is then coated and dried over a support, to form the surface layer.

The solvent used for the surface layer-forming solution, although not particularly limited, is exemplified by aliphatic solvents such as n-pentane, n-hexane, n-heptane, n-octane, cyclohexane and methylcyclohexane; ketone solvents such as methyl ethyl ketone, acetone and cyclohexanone; ether solvents such as diethyl ether, isopropyl ether, tetrahydrofuran, dioxane, ethylene glycol dimethyl ether, ethylene glycol diethyl ether, diethylene glycol dimethyl ether, diethylene glycol diethyl ether, propylene glycol monomethyl ether, anisole and phenetol; ester solvents such as ethyl acetate, butyl acetate and ethylene glycol diacetate; aromatic solvents such as toluene and xylene; cellosolve-based solvents such as methyl cellosolve, ethyl cellosolve and butyl cellosolve; alcohol-based solvents such as methanol, ethanol, propanol and isopropyl alcohol; halogen-containing solvents such as dichloromethane and chloroform; nitrile-based solvents such as acetonitrile and propionitrile; polar solvents such as N-methyl-2-pyrrolidone, N-ethyl-2-pyrrolidone, N,N-dimethylformamide and N,N-dimethylacetamide; and the like. These solvents can be used singly or in combination of two or more kinds thereof.

The total content of the resin and the stimulus-responsive compound in the surface layer-forming solution, although not particularly limited, is preferably 30 to 60% by mass.

Examples of a method for applying the surface layer onto the support include a spin coating; dip coating; flow coating; methods with use of liquid film coating apparatus such as roll coater, rod coater, curtain coater, slide coater, doctor knife, screen coater, slot coater, extrusion coater, blade coater, gravure coater or inkjet coater; and the like.

Application of the coating liquid may be optionally followed by air drying, and then drying with use of a vacuum dryer or the like, whereby an ink film-forming press plate can be obtained. The drying temperature, when using the vacuum dryer, is preferably 25 to 40° C., although not particularly limited. The drying time, although not particularly limited, is preferably 1 to 4 hours.

When manufacturing the press plate having the adhesive layer between the support and the surface layer, it suffices to provide the adhesive layer on the support by the method described in the section of (Adhesive Layer), and to form the surface layer on the adhesive layer.

[Platemaking Apparatus]

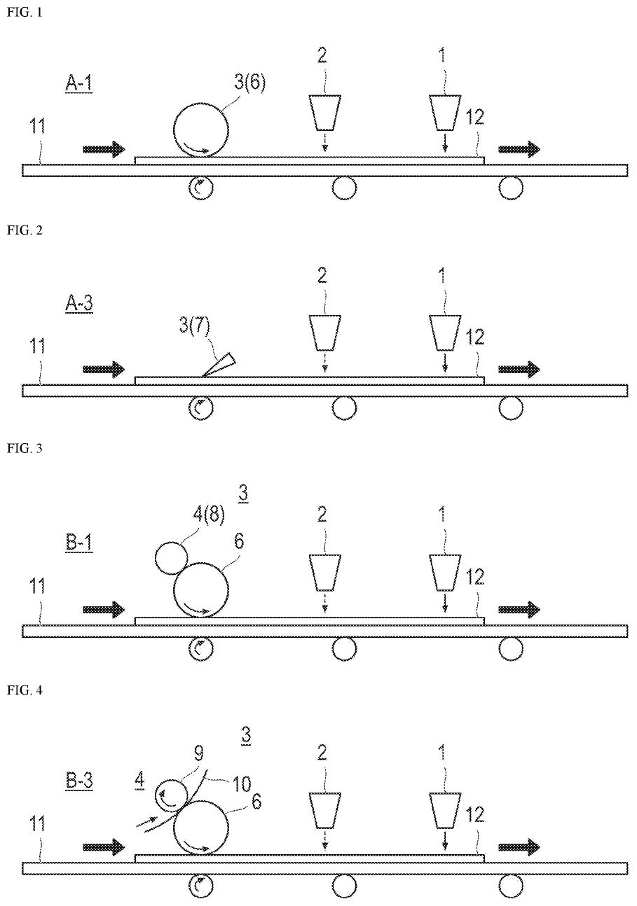

FIG. 1 is a schematic drawing illustrating a platemaking apparatus A-1 according to an embodiment of the present invention. The platemaking apparatus A-1 is a platemaking apparatus for forming a pattern on the ink film-forming press plate 12 (also referred to as “press plate 12”) in a repeatedly rewritable manner. The platemaking apparatus A-1 having a structure as illustrated in FIG. 1 includes a first stimulator 1, a second stimulator 2 and a cleaning unit 3, in which a press plate 12 placed on a conveying belt 11 passes the cleaning unit 3, the second stimulator 2 and the first stimulator 1 in this order in the direction of the arrows.

(First Stimulator)

In the platemaking apparatus according to one embodiment of the present invention, the first stimulus (solid arrow in FIG. 1) output from the first stimulator 1 is applied to the surface layer on the press plate 12. The first stimulus changes a physical property of the surface of the press plate 12 from a first physical property to a second physical property. The first stimulator 1 draws a pattern of the press plate 12, which includes an printing area and a non-printing area, by changing the physical property of the surface of the press plate 12 with use of the first stimulus. The pattern of the press plate 12 is drawn on the basis, for example, of image data to be printed. For example, a pattern that includes a hydrophilic area and a hydrophobic area is formed.

In a case where the surface layer of the press plate 12 contains the photoresponsive compound, the first stimulator 1 as a writing means (a writing unit) may be a known light source such as light emitting diode (LED) and monochromatic laser light source. Also in a case where the surface layer of the press plate 12 contains the temperature-responsive compound, the first stimulator 1 as a writing means (a writing unit) may be infrared lamp, monochromatic laser light source, or the like. These may be installed singly or in combination of two or more units.

Upon partly applying the external stimulus from the first stimulator 1 to the ink film-forming press plate 12, a pattern composed of a first physical property area and a second physical property area is formed in the surface layer of the press plate 12. Note that “partly applying the external stimulus” in the present specification means applying the external stimulus to either an image area or a non-image area of the image pattern to be written.

As described above, the stimulus-responsive compound is preferably the photoresponsive compound or the temperature-responsive compound. The external stimulus applied by the first stimulator 1 is therefore preferably light or temperature change.

In a case where the surface layer of the press plate 12 contains the photoresponsive compound, then the external stimulus is light. In this case, wavelength region of the light emitted from the writing means (preferably, a monochromatic laser light source) is not particularly limited. For example, given the compound represented by chemical formula (1), or a polymer having a skeleton derived from the compound represented by chemical formula (1) is used, photoisomerization from trans form to cis form occurs under irradiation of light of 200 to 400 nm, changing the surface physical property from hydrophobic to hydrophilic. In this process, the non-image area irradiated with light turns into hydrophilic. Meanwhile, the image area, or non-irradiated area, remains hydrophobic, and can take part in printing with use of a hydrophobic ink. The wavelength of the light is more preferably 280 to 400 nm. In such wavelength region, the light can be irradiated to finer area, enabling sharp reproduction of small letter or fine image. In addition, since the energy received by the surface layer is not too large, so that the surface layer is less likely to deteriorate and can withstand repeated rewriting operations.

In addition, for example, in a case where the compound represented by chemical formula (1) or a polymer having a skeleton derived from the compound represented by chemical formula (1) is used, photoisomerization from cis form to trans form occurs under irradiation of visible light (preferably visible light in a wavelength region of 400 to 600 nm, more preferably visible light in a wavelength region of 430 to 600 nm), changing the surface physical property from hydrophilic to hydrophobic. In this process, the image area irradiated with light turns into hydrophobic, and can take part in printing with use of a hydrophobic ink. In a case where the press plate has never been used, the surface physical property is preferably turns into hydrophilic in advance, typically by applying the second stimulus to the entire surface of the press plate 12 with use of the second stimulator described below.

Irradiation dose of the first stimulus is preferably in the range from 1 to 30 Jim′, for example. Within this range, small letter or fine image can be sharply written, enabling writing without excessive load on the surface layer.

In a case where the surface layer of the press plate 12 contains the temperature-responsive compound, then the external stimulus is temperature change. Since the aforementioned temperature-responsive compound has a critical solution temperature, so that the temperature change of the surface layer is applied across the critical solution temperature, so as to form the pattern composed of the hydrophilic area and the hydrophobic area in the surface layer of the press plate 12. The first stimulator 1, which is a writing means to be used here, is preferably a monochromatic laser light source that emits light with a wavelength range of 700 to 900 nm. The writing means enables selective heating, whereby the pattern is formed.

Given that a variety of light sources are used as the first stimulator 1, the light from the light sources is preferably irradiated on the surface of the press plate 12, in a form of tiny spot (pin spot) or thin line, so that only the stimulus-responsive compound, to which the external stimulus is applied, will change the hydrophilicity. For example, the pin spot may be formed by various methods, including an irradiation method by which light from a light source irradiated after guided through an optical fiber; a lens reduction method in which a plurality of light sources are arranged in the direction of travel of the press plate 12, and the light therefrom is irradiated after reduced through lenses, in the direction of travel of the press plate 12; and the like. The fine line may be formed, for example, by scanning laser light. Provided that a required dose of light can be supplied, also an irradiation system by projection of an image pattern is employable. Spot size and line width of light on the surface of the press plate 12 are preferably similar to the size of points (dots) that compose the printing area in usual offset printing. The image pattern is formed over the entire press plate 12, by light irradiation while moving the press plate 12.

The first stimulator 1, which is a writing means (a writing unit), may only be re-operable at least when printing a different printed material by changing the image pattern, and is not always necessarily be recycled when printing a plurality of the same printed materials. That is, the image pattern formed on the surface layer by a single operation of writing will be maintained as it is. Hence by setting the press plate with the image pattern written thereon typically on a printing apparatus, and by continuously transferring the ink film with use of a transfer unit of the printing apparatus, then a plurality of sheets can be printed without rewriting.

Therefore, in an exemplary case where a brand-new press plate is written for the first time, the press plate for printing is manufacturable by applying, in the printing apparatus A-1, only the first stimulus from the first stimulator 1, without cleaning by the cleaning unit 3 and application of the second stimulus by the second stimulator 2. The press plate is then set on the printing apparatus as described above, which is now ready to print.

(Second Stimulator)

The second stimulator 2 applies, to the surface of the press plate 12, the second stimulus (dotted arrow in FIG. 1) that changes the physical property of the surface of the press plate 12 from the second physical property to the first physical property. The press plate 12 in this timing may be a press plate on which a pattern has been formed on the surface by the above-mentioned first stimulator 1. The second stimulator 2 changes the second physical property area to the first physical property area, with use of the second stimulus. The second stimulator 2 erases the pattern composed of the printing area and the non-printing area from the surface of the press plate 12, by changing the physical property of the surface of the press plate 12 with use of the second stimulus.

In a case where the surface layer of the press plate 12 contains a photoresponsive compound, the second stimulator 2 that serves as an erasing means may be any of known light sources such as light emitting diode (LED) and monochromatic laser light source. For example, the light from the light source is irradiated on the surface of the press plate 12, in the form of diffused light or linear beam through a lens or the like, in the direction of travel of the press plate 12. The light that serves as the second stimulus is preferably uniform in the direction of travel of the press plate 12, while allowing some variation provided that the light as the second stimulus is intense enough to erase the pattern from the surface of the press plate 12. The light that serves as the second stimulus may alternatively be irradiated by scanning laser light in the direction of travel of the press plate 12.

The wavelength region of the light as the second stimulus irradiated by the second stimulator 2 is not particularly limited. For example, in a case where the compound represented by chemical formula (1) or a polymer having a skeleton derived from the compound represented by chemical formula (1) is used, and where the wavelength of the light as the first stimulus from the first stimulator 1 is 200 to 400 nm, the wavelength of light as the second stimulus from the second stimulator 2 is preferably 400 to 600 nm. Similarly, in a case where the wavelength of light as the first stimulus from first stimulator 1 ranges from 400 to 600 nm, the wavelength of light as the second stimulus from the second stimulator 2 preferably ranges from 200 to 400 nm, more preferably from 280 to 400 nm, and particularly preferably from 300 to 380 nm.

Irradiation dose of the second stimulus is preferably in the range from 1 to 30 Jim′, for example. Within this range, the image pattern can be easily erased, enabling erasure without excessive load on the surface layer.

In a case where the surface layer of the press plate 12 contains the temperature-responsive compound, the second stimulator 2 is exemplified by cold air generator capable of generating cold air at 5 to 20° C., thermostatic chamber set to 5 to 20° C., and so forth.

Upon erasure of the pattern with use of the second stimulator 2 as such erasing means (erasing unit), then the surface layer of the press plate 12 will have a surface property same as that before the external stimulus is applied. By the aforementioned writing operation, a new pattern can be formed in the surface layer. That is, the platemaking apparatus of the present embodiment can make it easier to rewrite the pattern in a digital mode.

(Cleaning Unit)

The platemaking apparatus of the present embodiment has the cleaning unit 3 that removes the ink remained on the surface of the press plate 12 after printing. The cleaning unit 3 preferably removes the ink adhered to the surface of the press plate 12, before erasure of the pattern of the press plate 12 by the second stimulator 2.

The cleaning unit 3 is not particularly limited, if only it can remove the ink remained on the press plate after used for printing. For example, although air knife, means for sucking ink with air or the like may otherwise be employable, the platemaking apparatus of the present embodiment preferably employs a contact member that is brought into contact with the press plate 12, and removes the ink remained on the surface of the press plate, by pressurizing the contact member against the press plate so as to make the ink adhered onto the contact member. In this way, the ink can be more effectively removed. Note that the contact member is preferably designed so that it can be brought into contact with, and brought away from the surface of the press plate 12. For example, when writing into a brand-new press plate for the first time, or the like, the contact member is preferably brought away from the surface of the press plate.

Examples of the contact member employable here include cleaning roller, cleaning belt, cleaning blade and so forth, wherein the cleaning roller 6 such as in the platemaking apparatus A-1 illustrated in FIG. 1 is preferred since the ink may be evenly collected. The cleaning roller 6 more preferably has, on the surface thereof, a member that contains a material with high surface adhesiveness, in view of enabling efficient adhesion of the ink. The material with high surface adhesiveness is preferably selected from the group consisting of polyimide resin, nylon resin (polyamide resin), polyester resin, polyurethane resin and polycarbonate resin, wherein polyimide resin and/or nylon resin (polyamide resin) are particularly preferred.

In a case where a cleaning blade 7 is used as the contact member as in the platemaking apparatus A-3 illustrated in FIG. 2, the cleaning blade 7, when brought into contact with the surface of the press plate 12, is preferably arranged so that the end of the blade is in the opposite direction (counter direction) to the direction of travel of the press plate 12.

The cleaning blade 7 employable here is, for example, a squeegee blade made of an elastomer such as polyurethane or silicone rubber. Such squeegee blade comes into contact with the surface of the press plate 12 to squeegee (scrape) and remove the ink.

In a case where the cleaning roller 6 is used as the contact member as in the platemaking apparatus B-1 illustrated in FIG. 3, the cleaning unit 3 preferably further has an ink collector 4 that collects the ink adhered to the cleaning roller 6. The ink adhered onto the press plate 12 can therefore be removed more certainly. The ink collector 4 preferably has a member (ink absorbent member) 8 with high ink absorbability that is attached to a support member (not illustrated) typically made of resin or metal, and is arranged in contact with the surface of the cleaning roller 6, so as to remove the ink by absorbing it or wiping it off from the surface of the cleaning roller 6. The member 8 with high ink absorbability preferably used here may be woven fabric, nonwoven fabric or sponge. With such structure, the ink adhered to the cleaning roller 6 can be blotted by the member 8 with high ink absorbability, and the ink adhered to the press plate 12 can be more certainly removed.

Alternatively as in a platemaking apparatus B-3 illustrated in FIG. 4, the ink collector 4 may have a press roller 9 arranged in contact with the cleaning roller 6, and a cleaning paper 10 fed between the cleaning roller 6 and the press roller 9, intended for collecting the ink adhered on the cleaning roller 6 by transferring it onto the cleaning paper 10. Such structure can remove the ink adhered on the cleaning roller 6 with use of the cleaning paper 10, whereby the ink adhered on the press plate 12 can be removed more certainly.

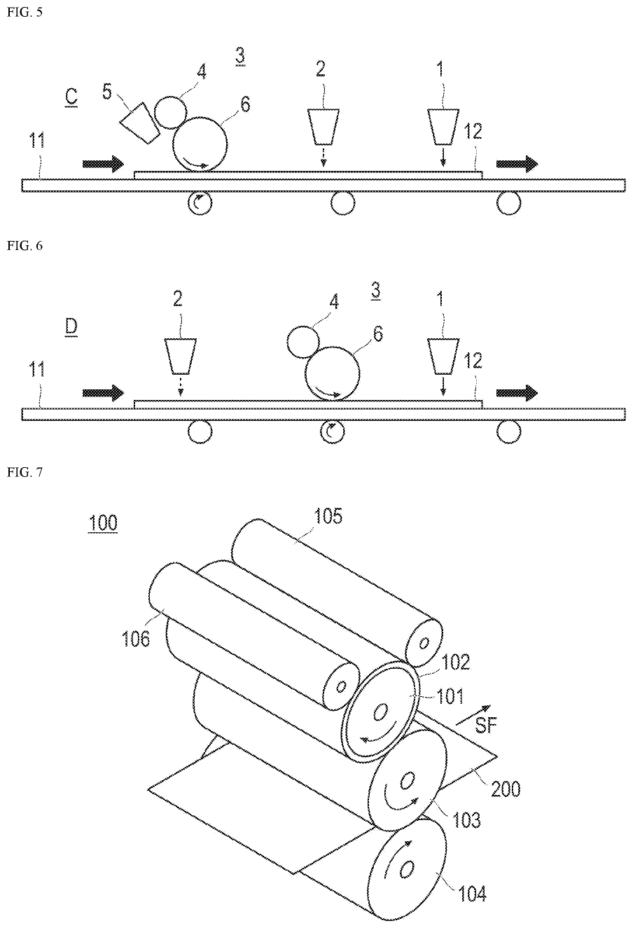

The cleaning unit 3 preferably further has, as in the platemaking apparatus C illustrated in FIG. 5, a third stimulator 5 that applies an external stimulus (third stimulus) to at least either the surface of the press plate or the residual ink, at least in either stage before ink removal or concurrently with ink removal.

The third stimulus applied from the third stimulator 5 preferably changes state of the surface of the press plate 12 or the residual ink (ink remained on the press plate 12). Specifically, the third stimulus preferably changes the physical property of the surface of the press plate 12 or the physical property of the ink, so as to reduce affinity between the surface of the press plate 12 and the ink. For example, the state of the surface of the press plate 12 or the remained ink can be changed before reaching, or concurrently with reaching the cleaning roller 6, by arranging the third stimulator 5 downstream of the cleaning roller 6, and by applying the third stimulus to the surface of the press plate 12 at or downstream of a contact point between the cleaning roller and the press plate 12, thereby assisting the ink removal.

As the third stimulator 5, UV light source or a heat source can be installed. The state of the residual ink can therefore be changed, typically by a method of curing or drying the residual ink.

The third stimulator 5 employable here include light source such as an LED light source, heat source, means for providing electrical stimulation, and the like, whereby the state of the surface of the press plate 12 can be changed, typically by a method of changing the surface morphology so as to reduce the adhesiveness of the ink, or changing the physical property of the surface such as hydrophilicity, hydrophobicity, and the like.

In particular in view of effectively assisting removal of the residual ink, the external stimulus applied by the third stimulator is preferably the same type of stimulus as the first stimulus or the second stimulus. Now, the same type of stimulus means, for example, that given that the first stimulus or the second stimulus is light, then the third stimulus is also light; and given that the first stimulus or the second stimulus is heat (temperature change), then the third stimulus is also heat; and means the light with a certain wavelength or temperature change capable of causing change of physical property of the surface of the press plate (from the first physical property to the second physical property, or from the second physical property to the first physical property), just like either the first stimulus or the second stimulus. For example, if the first stimulus or the second stimulus is light, the third stimulus is preferably light whose center wavelength falls within a ±50 nm range on both sides of the center wavelength of either light. Note now that the light from the light source is preferably irradiated over the entire surface of the press plate 12, for example, in the form of diffused light or linear beam, preferably with an irradiation dose ranging for example from 0.1 to 30 J/cm². For example, if the first stimulus or the second stimulus is heat, the third stimulus is preferably heat whose temperature falls within a ±15° C. range on both sides of the heating temperature of either stimulus. The third stimulus is preferably light output from the same light source as either the first stimulus or the second stimulus, or light of the same wavelength. Alternatively, the third stimulus is the same temperature change as either the first stimulus or the second stimulus.

(Rewriting of Press Plate)

The press plate 12, when being brand-new, has no ink supplied on the surface of the press plate 12. With the press plate 12 that is brand-new, the first stimulus is applied from the first stimulator 1 to the surface of the press plate 12 while moved, thereby forming a desired pattern. The pattern is thus formed on the press plate 12.

When rewriting the press plate 12, the press plate 12 after printing is allowed to pass, as illustrated in FIG. 1, the cleaning unit 3, the second stimulator 2 and the first stimulator 1 of the platemaking apparatus A-1 in this order with use of a known conveying means such as the conveying belt 11, thereby enabling removal of the residual ink on the press plate after printing by the cleaning unit 3, erasure of the pattern by the second stimulator 2, and rewriting of the pattern by the first stimulator 1 in this order.

Alternatively, the press plate 12 after printing is allowed to pass, as illustrated in FIG. 6, the second stimulator 2, the cleaning unit 3 and the first stimulator 1 of the platemaking apparatus D in this order, thereby enabling erasure of the pattern by the second stimulator 2, removal of the ink remained on the press plate by the cleaning unit 3, and rewriting of the pattern by the first stimulator 1 in this order.

In the platemaking apparatus of the present embodiment, the press plate 12, however, preferably passes the cleaning unit 3, the second stimulator 2, and the first stimulator 1 in this order. In this way, both the second stimulus and the first stimulus can be applied with a reduced amount of ink remained on the press plate after printing. Therefore, both the change in the state of the surface by the second stimulus and the change in the state of the surface by the first stimulus can reliably proceed. As a result, fogging with the previous image can be further reduced.

[Platemaking Method]

The present invention also provides a platemaking method that forms a pattern on the ink film-forming press plate in a repeatedly rewritable manner. That is, one embodiment of the present invention relates to a platemaking method that includes: applying, to a surface of an ink film-forming press plate that has a surface layer containing a stimulus-responsive compound whose physical property can reversibly change in response to an external stimulus, a first stimulus that changes the physical property of the surface from a first physical property to a second physical property to form a pattern, on the basis of image data; forming an ink film on either an image area or a non-image area of the press plate having the pattern formed thereon; performing printing with use of the press plate having the ink film formed thereon; applying, to a surface of the press plate after printing, a second stimulus that changes the physical property of the surface from the second physical property to the first physical property, to erase the pattern; forming a new image pattern by applying the first stimulus to the surface of the press plate from which the pattern has been erased; and cleaning the ink remained on the surface of the press plate after the printing, in either timing after the printing and before the applying of the second stimulus, or after the applying of the second stimulus and before the forming of the new image pattern.

Specific modes of the applying of the first stimulus (the first stimulation step of applying), the applying of the second stimulus (the second stimulation step of applying) and the cleaning step are same as described above, so the explanation will be omitted. Note that the forming the new image pattern (the step of forming the new image pattern) is similar to the first stimulation step of applying, except that, after printing, the first stimulus based on new image data is applied to the press plate from which the pattern has been erased.

To the step of forming the ink film on either the image area or the non-image area of the press plate having the pattern formed thereon, and to the step of performing printing with use of the press plate having the ink film formed thereon, any of known means such as a printing method with use of a usual offset printing machine is suitably applicable.

In the step of forming the ink film, the ink is applied to the pattern formed in the first stimulation step of applying to form the ink film. Also means for applying the ink is also not particularly limited. Note that “forming the ink film” in the present specification means that the ink is retained at a predetermined point (for example, hydrophilic area or hydrophobic area) of the pattern, in a transferable manner onto a printable medium.

The ink may only be transferable onto the printable medium without special limitation, to which any of known inks such as water-based ink, oil-based ink and emulsion ink is applicable. With the water-based ink, the ink film is formed in the hydrophilic area of the pattern. With the oil-based ink or emulsion ink, the ink film is formed in the hydrophobic area of the pattern.

Now by repeating the aforementioned second stimulation step of applying, the step of forming the new image pattern, the cleaning step, the step of forming the ink film, and the step of performing printing, every time at least one sheet is printed, the press plate can be repeatedly rewritten for printing.

[Printing Apparatus]

Printing is enabled by mounting, on a printing apparatus, the press plate on which the pattern was formed by using the platemaking apparatus of the present embodiment. FIG. 7 is a perspective view illustrating a main part of the printing apparatus for printing with use of the aforementioned press plate.

The printing apparatus illustrated in FIG. 7 is an offset printing apparatus. As illustrated in FIG. 7, the printing apparatus 100 has a plate cylinder 101, a blanket 103, an impression cylinder 104, an ink roller 105, and a dampening roller (a dampening water roller) 106.

On the surface of the plate cylinder 101, there is mounted a press plate 102, having on the surface thereof the pattern composed of the printing area and the non-printing area, manufactured by using the platemaking apparatus of the present invention. Hereinafter, the plate cylinder 101 and the press plate 102 will be explained as an integrated component. The surface of the plate cylinder 101 is therefore understood to be the surface of the press plate 102.

For example, the printing area can be a hydrophobic (lipophilic) area capable of retaining thereon a hydrophobic ink, and the non-printing area can be a hydrophilic area capable of retaining thereon water. As described above, the surface of the press plate 102 enables thereon rewriting of the pattern that is composed of the printing area and the non-printing area.

The ink having been adhered on the plate cylinder 101 is transferred onto the blanket 103, and the ink adhered on the blanket 103 is then transferred onto a paper 200. The impression cylinder 104 pressurizes the paper 200 conveyed between itself and the blanket 103, against the blanket 103. The ink roller 105 supplies the ink fed from an ink tank or the like (not illustrated), to the plate cylinder 101. The dampening roller 106 supplies water for dampening the plate cylinder 101, to the plate cylinder 101. The plate cylinder 101, the blanket 103, the impression cylinder 104, the ink roller 105 and the dampening roller 106 roll (in the directions indicated by the arrows in the drawing), in synchronization with conveyance of the paper 200. Note that the direction of conveyance of the paper 200 is indicated by an arrow SF in the drawing. Except for the press plate, the structures and printing operations of the plate cylinder 101, the blanket 103, the impression cylinder 104, the ink roller 105, and the dampening roller 106 are similar to those of an ordinary offset printing apparatus.

That is, one embodiment of the present invention relates to a printing apparatus that includes: a plate cylinder having mounted on the surface thereof an ink film-forming press plate on which a pattern is formed by using the platemaking apparatus according to one embodiment of the present invention; a blanket arranged in contact with the surface of the press plate; an impression cylinder that sandwiches a printable medium between itself and the blanket, and pressurizes the printable medium against the blanket; and an ink roller that supplies ink to the press plate.

Moreover, one embodiment of the present invention relates to a printing method with use of a printing apparatus that includes a plate cylinder on which a press plate can be mounted on a surface thereof; a blanket arranged in contact with a surface of the press plate; an impression cylinder that sandwiches a printable medium between itself and the blanket, and pressurizes the printable medium against the blanket; and an ink roller that supplies an ink to the press plate, and the printing method includes mounting, on the surface of the plate cylinder, an ink film-forming press plate having a pattern formed on the surface thereof by using the platemaking apparatus of the present invention. By rewriting the press plate by using the platemaking apparatus as an external device, workability can be improved as compared with a case where rewriting is performed by installing a writing means (a writing unit) or an erasing means (an erasing unit) in a main part of the printing apparatus illustrated in FIG. 7. In addition, the time loss of printing due to rewriting of the press plate can be reduced.

### EXAMPLES

Hereinafter, the present invention will be specifically described with reference to Examples, to which the present invention is by no means limited. Note that notification of “part(s)” or “%” used in Examples mean “part(s) by mass” or “% by mass”, unless otherwise specified.

<Synthesis of Azobenzene Compound (Azobenzene Derivative (Polymer 2)) Represented by Chemical Formula (6)>

To 3-chloro-4-(hexyloxy)aniline (13.66 g, 60 mmol), 75 mL of 2.4 N hydrochloric acid was added, the mixture was kept stirred under cooling at 0° C., to which a solution obtained by dissolving sodium nitrite (4.98 g, 72 mmol) in 6 mL of distilled water was added, and the mixture was further kept stirred at 0° C. for 60 minutes. To this solution, a mixed solution of 2-chlorophenol (7.71 g, 60 mmol) and 24 mL of a 20% aqueous sodium hydroxide solution was added, and the mixture was stirred for 20 hours. A produced precipitate was collected by filtration, and the obtained solid was washed with water. The obtained solid was purified by silica gel column chromatography with use of a mixed solution of ethyl acetate and hexane as an eluent, to obtain Intermediate C (see reaction formula C for the structure). To intermediate C (7.35 g, 20 mmol), 100 mL of DMF, 3-bromo-1-hexanol (10.9 g, 60 mmol) and potassium carbonate (6.91 g, 50 mmol) were added, the mixture was stirred at 80° C. for 2 hours, and further kept under stirring at room temperature (25° C.) for 20 hours. After distilling off the solvent under reduced pressure, the residue was extracted with ethyl acetate, the organic layer was washed with saturated brine, and then dried over anhydrous magnesium sulfate. The organic layer was filtered, the solvent was distilled off under reduced pressure, and the resultant solid was purified by silica gel column chromatography with use of a mixed solution of ethyl acetate and hexane as an eluent, to obtain intermediate D (see reaction formula C for the structure). To the intermediate D (4.67 g, 10 mmol), 100 mL of tetrahydrofuran was added to prepare a tetrahydrofuran solution of intermediate D. Besides this, a mixture of acryloyl chloride (1.09 g, 12 mmol) and triethylamine (2.43 g, 24 mmol) was prepared, to which the tetrahydrofuran solution of intermediate D was added dropwise at 0° C., the mixture was subsequently stirred at 0° C. for 30 minutes, then heated up to room temperature (25° C.), and further stirred at room temperature (25° C.) for 2 hours. The obtained reaction liquid was washed with water and saturated brine, the solvent was then distilled off under reduced pressure, and the residue was recrystallized from methanol to obtain intermediate E. To intermediate E (2.61 g, 5 mmol), 12 mL of a 20% aqueous sodium hydroxide solution was added, the mixture was stirred at 340° C. and 150 atm for 2 hours, to which 10 mL of 1.2 N hydrochloric acid was added, and the mixture was stirred at room temperature (25° C.) for 1 hour. The mixture was extracted with ethyl acetate, and the organic layer was washed with saturated brine, and then dried over anhydrous magnesium sulfate. This organic layer was filtered, the solvent was distilled off under reduced pressure, and the resultant solid was purified by silica gel column chromatography by using a mixed solution of ethyl acetate and hexane as an eluent, to obtain intermediate F. To intermediate F (1.45 g, 3 mmol), 5 mL of tetrahydrofuran was added, then 5% by mass, relative to the intermediate F, of 2,2-azobisisobutyronitrile (AIBN) as a polymerization initiator was further added, and the mixture was stirred at 70° C. for 20 hours. Thereafter, reprecipitation was allowed to occur by adding ethanol, to obtain an azobenzene derivative (polymer 2) (see Chemical Formula (6)). The obtained polymer 2 was found to have a value of x, which is the number of repeating unit in chemical formula (6), of approximately 100.

(Manufacture of Ink Film-Forming Press Plate (M-1))

Mixed were 1200 parts by mass of dichloromethane, 1200 parts by mass of toluene, 950 parts by mass of the azobenzene derivative (polymer 2) synthesized above as the photoresponsive compound, and 950 parts by mass of a styrene acrylic resin (US-1071, from SEIKO PMC Corporation) as the thermoplastic resin, under stirring at 50° C. for 1 hour to obtain a solution. The solution was allowed to thoroughly disperse using a paint shaker at room temperature (25° C.) for 30 minutes, and then applied over an electropolished flat aluminum substrate (360 mm long X 180 mm wide) as a support with use of a blade coater, so as to achieve a dry thickness of 6 μm. The paint film was air-dried for 30 minutes, and then dried at 30° C. for 2 hours using a vacuum dryer, to obtain an ink film-forming press plate (M-1).

The manufactured ink film-forming press plate (M-1) was confirmed to have a hydrophobic surface, since the surface on which water was entirely applied with use of a water roller was found to repel the water.

<Platemaking Apparatus>

(Platemaking Apparatus A-1)

A platemaking apparatus A-1 having a structure as illustrated in FIG. 1 has the first stimulator 1, the second stimulator 2 and the cleaning unit 3, in which the press plate 12 placed on the conveying belt 11 passes the cleaning unit 3, the second stimulator 2 and the first stimulator 1 in this order. A monochromatic laser light source with a wavelength of 465 nm was installed as the first stimulator 1, monochromatic laser light source with a wavelength of 365 nm was installed as the second stimulator 2, and the cleaning roller 6 whose surface layer was made of polyimide (PI) resin was installed as the cleaning unit 3.

(Platemaking Apparatus A-2)

For a platemaking apparatus A-2, the cleaning roller 6 whose surface layer is made of nylon resin was installed as the cleaning unit 3. Other aspects of the structure (not illustrated) were same as those in the platemaking apparatus A-1.

(Platemaking Apparatus A-3)

For a platemaking apparatus A-3 illustrated in FIG. 2, a cleaning blade 7 made of polyurethane resin was installed as the cleaning unit 3. Other aspects of the structure were same as those in the platemaking apparatus A-1.

(Platemaking Apparatus B-1)

The platemaking apparatus B-1 having a structure as illustrated in FIG. 3 has the ink collector 4 arranged in contact with the cleaning roller 6, which was additionally installed on the platemaking apparatus A-1. The ink collector 4 collects the ink adhered on the cleaning roller 6 with a web (ink absorbent member 8) made of a nonwoven fabric.

(Platemaking Apparatus B-2)

In a platemaking apparatus B-2, the ink collector 4 collects the ink adhered on the cleaning roller 6 with a web (ink absorbent member 8) made of a woven fabric. Other aspects of the structure (not illustrated) were same as those in the platemaking apparatus B-1.

(Platemaking Apparatus B-3) As illustrated in FIG. 4, the ink collector 4 of the platemaking apparatus B-3 feeds the cleaning paper 10 between the cleaning roller 6 and the press roller 9 in a direction indicated by an arrow, and blots up the ink adhered on the cleaning roller 6 with the cleaning paper 10. Other aspects of the structure were same as those in the platemaking apparatus B-1.

(Platemaking Apparatus C)

The platemaking apparatus C having a structure as illustrated in FIG. 5 has the third stimulator 5 placed just ahead of a contact point between the cleaning roller 6 and the press plate 12, as additionally installed on the platemaking apparatus B-1. The third stimulator 5 was provided with a monochromatic laser light source having a wavelength of 365 nm, just like in the second stimulator 2.

(Platemaking Apparatus D)

A platemaking apparatus D having a structure as illustrated in FIG. 6 has the first stimulator 1, the second stimulator 2, and the cleaning unit 3 that includes the cleaning roller 6 and the ink collector 4 arranged in contact with the cleaning roller 6, in which the press plate 12 placed on the conveying belt 11 passes the second stimulator 2, the cleaning unit 3 and the first stimulator 1 in this order. A monochromatic laser light source with a wavelength of 465 nm was installed as the first stimulator 1, monochromatic laser light source with a wavelength of 365 nm was installed as the second stimulator 2, and a cleaning roller 6 whose surface layer was made of polyimide resin was installed in the cleaning unit 3. The ink collector 4 collects the ink adhered on the cleaning roller 6 with a web (ink absorbent member 8) made of a nonwoven fabric.

(Platemaking Apparatus E)

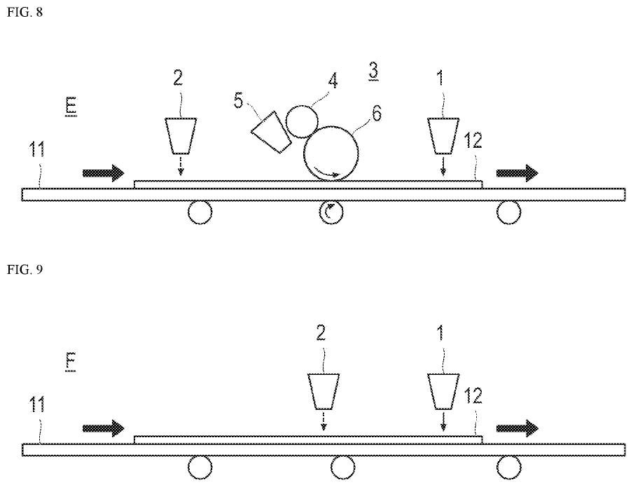

A platemaking apparatus E having a structure as illustrated in FIG. 8 has the third stimulator 5 placed just ahead of a contact point between the cleaning roller 6 and the press plate 12, as additionally installed on the platemaking apparatus D. The third stimulator 5 was provided with a monochromatic laser light source having a wavelength of 365 nm, just like in the second stimulator 2.

(Platemaking Apparatus F)

A platemaking apparatus F having a structure as illustrated in FIG. 9 has the first stimulator 1 and the second stimulator 2, in which the press plate 12 placed on the conveying belt 11 pass the second stimulator 2 and the first stimulator 1 in this order.

### Example 1

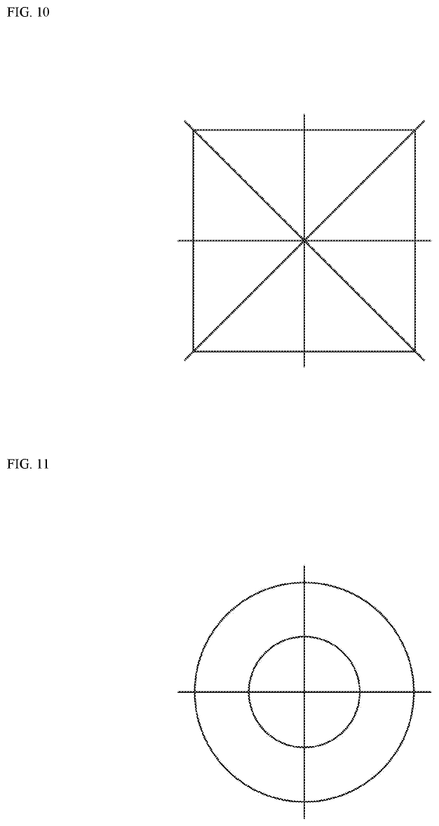

The ink film-forming press plate (M-1) prepared above was allowed to pass through the platemaking apparatus A-1, and the entire surface layer of the press plate was irradiated by the second stimulator with laser light having a wavelength of 365 nm at an irradiation dose of 3 J/cm². The cleaning roller at this timing was kept apart from the surface of the press plate, and was not used for cleaning prior to the photo-irradiation by the second stimulator. A separate press plate after the photo-irradiation was subjected to application of water entirely over the surface layer of the press plate with use of a water roller, and the surface layer was found evenly wet, thus confirmed that the surface layer of the press plate (M-1) entirely became hydrophilic after the photo-irradiation (irradiation dose: 3 J/cm²) by the second stimulator. Next, a monochromatic laser beam with a wavelength of 465 nm was irradiated at an irradiation dose of 3 J/cm² by the first stimulator, to the image area of an image which will be output as illustrated in FIG. 10. An ink film-forming surface (m11) was thus formed, in which the photo-irradiated area, or the image area, was turned into a hydrophobic area, while the non-image area remained hydrophilic. Note that FIG. 10 is a drawing illustrating a pattern on the surface of the press plate in the initial printing, wherein the pattern has a printing area with a line width of 0.1 mm.

Next, the press plate having the ink film-forming surface (m11) was mounted on the plate cylinder of the offset printing machine, and put into continuous printing for 1000 sheets. The photo-irradiated area formed by the first stimulator was confirmed to be output as the image area.

The offset printing machine employed here was LITHRONE 26 from Komori Corporation. Printing was performed with use of TOYO KING NEX (registered trademark) series, which is a hydrophobic ink from TOYO INK Co., Ltd., and Pearl Coat N from Mitsubishi Paper Mills, Ltd. as a printable medium.

Next, the press plate was detached from the offset printing apparatus, and handed over the platemaking apparatus A-1 for cleaning of the residual ink on the press plate, erasure of the image pattern by the second stimulator, and rewriting by the first stimulator.

Specifically, the ink was cleaned by using a cleaning roller whose surface was made of a polyimide resin, and then the entire surface layer of the press plate was irradiated with laser light having a wavelength of 365 nm at an irradiation dose of 3 J/cm² by the second stimulator. Next, a monochromatic laser beam with a wavelength of 465 nm was irradiated on the image area of an image which will be output as illustrated in FIG. 11, at an irradiation dose of 3 J/cm² by the first stimulator. FIG. 11 is a drawing illustrating a pattern on the surface of the press plate in rewriting, wherein the pattern has a printing area with a line width of 0.1 mm. An ink film-forming surface (m12) was thus formed, in which the photo-irradiated area, or the image area, was turned into a hydrophobic area, while the non-image area remained hydrophilic. Note that a separate press plate after stimulated by the second stimulator, but taken out before being stimulated by the first stimulator, was subjected to application of water entirely over the surface thereof by water roller, and the surface was found evenly wet, thus confirmed that the pattern had been erased.

Next, the press plate having the ink film-forming surface (m12) was mounted on the plate cylinder of the offset printing machine, and put into continuous printing for 100 sheets. The printed image on the 100th sheet (printed image on the 100th sheet after rewriting) was evaluated regarding fogging as described later.

(Stability of Repetitive Use of Platemaking Apparatus)

Further, 10 press plates were continuously subjected to cleaning, erasure of the image pattern and rewriting by using the platemaking apparatus A-1, according to the method described above. That is, 10 separate press plates were prepared, and each of the first through tenth press plates was subjected to the sequential steps of writing of the pattern illustrated in FIG. 10, printing, cleaning, erasure of the image pattern, and rewriting of the pattern illustrated in FIG. 11. The 10th press plate was mounted on the plate cylinder of the offset printing machine, and put into continuous printing for 100 sheets. The printed image on the 100th sheet (printed image on the 100th sheet after rewriting) was evaluated regarding fogging as described later.

### Example 2

The evaluation was conducted in the same way as in Example 1, except that the platemaking apparatus A-2 was used.

### Example 3

The evaluation was conducted in the same way as in Example 1, except that the platemaking apparatus A-3 was used.

### Example 4

The evaluation was conducted in the same way as in Example 1, except that the platemaking apparatus B-1 was used, and except for aspects described later. The ink adhered to the cleaning roller was collected by using a web made of a nonwoven fabric. The cleaning roller after passing the web was confirmed that the ink had been removed therefrom.

### Example 5

The evaluation was conducted in the same way as in Example 1, except that the platemaking apparatus B-2 was used, and except for aspects described later. The ink adhered to the cleaning roller was collected by using a web made of a woven fabric. The cleaning roller after passing the web was confirmed that the ink had been removed therefrom.

### Example 6

The evaluation was conducted in the same way as in Example 1, except that the platemaking apparatus B-3 was used, and except for aspects described later. The ink adhered on the cleaning roller was collected by feeding paper (cleaning paper) between the cleaning roller and the opposing press roller. The cleaning roller after passing the paper feeding zone was confirmed that the ink had been removed therefrom.

### Example 7

The evaluation was conducted in the same way as in Example 1, except that the platemaking apparatus C was used, and except for aspects described later. The ink adhered to the cleaning roller was collected with the web made of a nonwoven fabric, and the entire surface layer of the press plate was irradiated with laser light having a wavelength of 365 nm at an irradiation dose of 1 J/cm² by using the third stimulator 5 placed just ahead of the cleaning roller.

### Example 8

The evaluation was conducted in the same way as in Example 1, except that the platemaking apparatus D was used, and except for aspects described later. Erasure of the image pattern by the second stimulator, cleaning of the residual ink on the press plate, and rewriting by the first stimulator were conducted in this order. The ink adhered to the cleaning roller was collected by using a web made of a nonwoven fabric. The cleaning roller after passing the web was confirmed that the ink had been removed therefrom.

### Example 9

The evaluation was conducted in the same way as in Example 1, except that the platemaking apparatus E was used, and except for aspects described later. Erasure of the image pattern by the second stimulator, cleaning of the residual ink on the press plate, and rewriting by the first stimulator were conducted in this order. The ink adhered to the cleaning roller was collected with the web made of a nonwoven fabric, and the entire surface layer of the press plate was irradiated with laser light having a wavelength of 365 nm at an irradiation dose of 1 J/m² by using the third stimulator 5 placed just ahead of the cleaning roller.

### Comparative Example 1

The evaluation was conducted in the same way as in Example 1, except that the platemaking apparatus F was used, and except for aspects described later. Since the platemaking apparatus F had no cleaning unit, so that when rewriting the press plate taken out from the offset printing apparatus in such platemaking apparatus F, erasure of the pattern by the second stimulator, and rewriting by the first stimulator were conducted without removing the residual ink on the press plate.

[Evaluation Method]

<Evaluation of Fogging>

The printed image was evaluated. The evaluation was conducted by printing an image with use of the rewritten pattern in each Example and Comparative Example, and observing the printed image magnified under a digital microscope “VHX-600” (from KEYENCE Corporation). On the obtained monitor image, thin lines, particularly those in a part corresponded to the pattern illustrated in FIG. 10, which is the initial image, were observed with use of an indicator, and evaluated according to the following criteria. Note that the previous image means the image of initial printing. From among the following criteria, A, B and C are acceptable for use without problems:

A: No fogging with previous image

B: Faint fogging with previous image seen partially

C: Faint fogging with previous image seen overall

D: Fogging with previous image seen definitely

Results of the evaluation are summarized in Table 1 below.

### [Table 1]

TABLE 1

| | | Example 1 | Example 2 | Example 3 | Example 4 | Example 5 |
|---|---|---|---|---|---|---|
| Platemaking apparatus | | A-1 | A-2 | A-3 | B-1 | B-2 |
| First stimulator | First stimulus | Light | Light | Light | Light | Light |
| | | irradiation | irradiation | irradiation | irradiation | irradiation |
| | | (465 nm) | (465 nm) | (465 nm) | (465 nm) | (465 nm) |
| | Applied area | Image area | Image area | Image area | Image area | Image area |
| Second stimulator | Second stimulus | Light | Light | Light | Light | Light |
| | | irradiation | irradiation | irradiation | irradiation | irradiation |
| | | (365 nm) | (365 nm) | (365 nm) | (365 nm) | (365 nm) |
| Cleaning unit | Contact member | CR | CR | CB | CR | CR |
| | | (PI resin) | (Nylon | | (PI resin) | (PI resin) |
| | | | resin) | | | |
| | Ink collector | None | None | None | Nonwoven | Woven |
| | | | | | fabric | fabric |
| | Third stimulus | None | None | None | None | None |
| | Position of | Ahead of second stimulator | | | | |
| | passage | | | | | |
| Ink film-forming press plate | | M-1 | M-1 | M-1 | M-1 | M-1 |
| Evaluation of | First press plate | A | A | B | A | A |
| fogging | | | | | | |
| | 10th press plate | C | C | C | B | B |
| | | | | | | Comparative |
| | | Example 6 | Example 7 | Example 8 | Example 9 | Example 1 |
| Platemaking apparatus | | B-3 | C | D | E | F |
| First stimulator | First stimulus | Light | Light | Light | Light | Light |
| | | irradiation | irradiation | irradiation | irradiation | irradiation |
| | | (465 nm) | (465 nm) | (465 nm) | (465 nm) | (465 nm) |
| | Applied area | Image area | Image area | Image area | Image area | Image area |
| Second stimulator | Second stimulus | Light | Light | Light | Light | Light |
| | | irradiation | irradiation | irradiation | irradiation | irradiation |
| | | (365 nm) | (365 nm) | (365 nm) | (365 nm) | (365 nm) |
| Cleaning unit | Contact member | CR | CR | CR | CR | None |
| | | (PI resin) | (PI resin) | (PI resin) | (PI resin) | |
| | Ink collector | Paper passed | Nonwoven | Nonwoven | Nonwoven | None |
| | | | fabric | fabric | fabric | |
| | Third stimulus | None | Light | None | Light | None |
| | | | irradiation | | irradiation | |
| | | | (365 nm) | | (365 nm) | |
| | Position of | Ahead of second stimulator | | Behind second stimulator | | None |
| | passage | | | | | |
| Ink film-forming press plate | | M-1 | M-1 | M-1 | M-1 | M-1 |
| Evaluation of | First press plate | A | A | B | B | D |
| fogging | | | | | | |
| | 10th press plate | B | A | C | B | D |

CR: cleaning roller
CB: cleaning blade

As is clear from Table 1 above, all of Example 1 to 9 with use of the platemaking apparatuses having the first stimulator, the second stimulator and the cleaning unit were found to show only less fogging with the previous image, when observed on the 100th sheet of printed image printed by using the first press plate after rewriting. From this, the previous pattern was found to be thoroughly erased by cleaning the residual ink on the press plate.

In contrast, Comparative Example 1 with use of the platemaking apparatus having no cleaning unit was found to show definite fogging with the previous image, on the printed image printed by using the press plate after rewriting. This is supposedly because the residual ink on the press plate disturbed the external stimulus to produce an area where the pattern of the previous image could not be erased, and this resulted in printing of the previous image even when the press plate having a new pattern rewritten thereon was used for printing.

All of Examples 1 to 9 using the platemaking apparatuses of the present invention were also found to show less fogging when the 10th press plates were used, proving that the pattern can be stably written and erased even after the platemaking apparatuses were repeatedly used.

Comparison among Examples 1 to 3 revealed that use of the cleaning roller in the cleaning unit further reduced the fogging.

Furthermore, additional provision of the ink collector as in Examples 4 to 7 was found to improve the fogging particularly when the 10th press plate was used. Provision of the ink collector successfully suppressed the cleaning unit from degrading the cleaning performance due to accumulation of the ink, and enabled thorough removal of the ink even during repeated use, and this supposedly improved fogging particularly when the 10th press plate was used.

Furthermore, additional provision of the third stimulator as in Example 7 enabled more thorough removal of the ink, and was found to improve the fogging particularly when the 10th press plate was used.

Although the embodiments of the present invention have been described and illustrated in detail above, it is obvious that these are illustrative and exemplary and not restrictive, and that the scope of the present invention should be interpreted by the appended claims. Further, the present invention is not limited to the above embodiments, instead allowing various modifications.

### REFERENCE SIGNS LIST

1 first stimulator
2 second stimulator
3 cleaning unit
4 ink collector
5 third stimulator
6 cleaning roller
7 cleaning blade
8 ink absorbent member
9 press roller
10 cleaning paper
11 conveying belt
12, 102 ink film-forming press plate
100 printing apparatus
101 plate cylinder
102 press plate
103 blanket
104 impression cylinder
105 ink roller
106 dampening roller (dampening water roller)
200 paper
A-1, A-3, B-1, B-3, C, D, E, F platemaking apparatus

What is claimed is:

1. A platemaking apparatus for forming a pattern on an ink film-forming press plate that has a surface layer containing a stimulus-responsive compound whose physical property can reversibly change in response to an external stimulus, the platemaking apparatus comprising:
a first stimulator that applies, to a surface of the press plate, a first stimulus that changes the physical property of the surface from a first physical property to a second physical property to form the pattern, on the basis of image data;
a second stimulator that applies, to the surface of the press plate, a second stimulus that changes the physical property of the surface from the second physical property to the first physical property, to erase the pattern; and
a cleaning unit that removes an ink remained on the surface of the press plate.

2. The platemaking apparatus according to claim 1, wherein the cleaning unit has a contact member that is brought into contact with the press plate, and removes the ink remained on the surface of the press plate, by pressurizing the contact member against the press plate so as to make the ink adhered onto the contact member.

3. The platemaking apparatus according to claim 2, wherein the contact member is a cleaning roller.

4. The platemaking apparatus according to claim 3, wherein the cleaning unit further includes an ink collector that collects the ink adhered to the cleaning roller.

5. The platemaking apparatus according to claim 4, wherein the ink collector includes an ink absorbent member arranged in contact with the cleaning roller to absorb the ink, and selected from the group consisting of woven fabric, non-woven fabric and sponge.

6. The platemaking apparatus according to claim 4, wherein the ink collector includes a press roller arranged in contact with the cleaning roller, and a cleaning paper fed between the cleaning roller and the press roller, and collects the ink adhered on the cleaning roller by allowing the ink to transfer onto the cleaning paper.

7. The platemaking apparatus according to claim 1, wherein the cleaning unit further includes a third stimulator that applies an external stimulus to at least one of the surface of the press plate or the remained ink, at least either timing before ink removal or during ink removal.

8. The platemaking apparatus according to claim 7, wherein the external stimulus given by the third stimulator is a type of stimulus similar to the first stimulus or the second stimulus.

9. The platemaking apparatus according to claim 1, wherein the first stimulus and the second stimulus are lights having wavelengths different from each other, and the stimulus-responsive compound is a photoresponsive compound; or the first stimulus and the second stimulus are temperature changes different from each other, and the stimulus-responsive compound is a temperature-responsive compound.

10. The platemaking apparatus according to claim 1, wherein the physical property of the surface of the press plate is changed from hydrophobic to hydrophilic by the first stimulus and from hydrophilic to hydrophobic by the second stimulus; or the physical property of the surface of the press plate is changed from hydrophilic to hydrophobic by the first stimulus and from hydrophobic to hydrophilic by the second stimulus.

11. The platemaking apparatus according to claim 1, wherein the press plate passes through the cleaning unit, the second stimulator and the first stimulator in this order; or the press plate passes through the second stimulator, the cleaning unit, and the first stimulator in this order.

12. The platemaking apparatus according to claim 11, wherein the press plate passes through the cleaning unit, the second stimulator, and the first stimulator in this order.

13. A platemaking method comprising:
applying, to a surface of an ink film-forming press plate that has a surface layer containing a stimulus-responsive compound whose physical property can reversibly change in response to an external stimulus, a first stimulus that changes the physical property of the surface from a first physical property to a second physical property to form a pattern, on the basis of image data;
forming an ink film on either an image area or a non-image area of the press plate having the pattern formed thereon;
performing printing with use of the press plate having the ink film formed thereon;
applying, to a surface of the press plate after printing, a second stimulus that changes the physical property of the surface from the second physical property to the first physical property, to erase the pattern;
forming a new image pattern by applying the first stimulus to the surface of the press plate from which the pattern has been erased; and
cleaning the ink remained on the surface of the press plate after the printing, in either timing after the printing and before the applying of the second stimulus, or after the applying of the second stimulus and before the forming of the new image pattern.

14. A printing method with use of a printing apparatus that includes a plate cylinder on which a press plate can be mounted on a surface thereof; a blanket arranged in contact with a surface of the press plate; an impression cylinder that sandwiches a printable medium between itself and the blanket, and pressurizes the printable medium against the blanket; and an ink roller that supplies an ink to the press plate, the printing method comprising: mounting, on a surface of the plate cylinder, an ink film-forming press plate having a pattern formed on the surface thereof by using the platemaking apparatus set forth in claim 1.
